(19) United States
(12) Patent Application Publication
(10) Pub. No.: US 2025/0350314 A1
(43) Pub. Date: Nov. 13, 2025

(54) MONOBIT CROSS POWER SPECTRAL DENSITY MEASUREMENT FOR SIMULTANEOUS TRANSMIT AND RECEIVE ANTENNA SELF-INTERFERENCE CANCELLATION

(71) Applicant: BAE Systems Information and Electronic Systems Integration Inc., Nashua, NH (US)

(72) Inventors: Jeffrey Feigin, Andover, MA (US); Mark D. Hickle, Merrimack, NH (US)

(73) Assignee: BAE Systems Information and Electronic Systems Integration Inc., Nashua, NH (US)

(21) Appl. No.: 18/657,923

(22) Filed: May 8, 2024

(51) Int. Cl. H04B 1/525; H04B 1/10; H04L 5/12

(52) U.S. Cl. CPC H04B 1/525; H04B 1/1027; H04L 5/12

(57) ABSTRACT

Techniques are disclosed for self-interference signal cancellation. A self-interference cancellation method includes measuring an error between an output of a hardware cancellation circuit and an output of a software model of the hardware cancellation circuit. The method further includes estimating an amplitude error, a phase error, and a delay error based on the measured error and the output of the hardware cancellation circuit, and locating a largest frequency domain error peak in the measured error. The method further includes applying an all-pass filter to the estimated and measured signals at the peak error frequency to produce a filtered estimated signal and a filtered measured signal and optimizing the filtered estimated signal and the filtered measured signal to obtain an optimized canceller setting. The optimized canceller setting is provided to the hardware cancellation circuit.

### STATEMENT OF GOVERNMENT INTEREST

This invention was made with government support under prime contract number FA8650 21 C 7002 awarded by the United States Air Force. The government has certain rights in the invention.

### FIELD OF THE DISCLOSURE

This disclosure relates generally to the field of communication systems, and more particularly, to a self-interference cancellation (SIC) circuit for simultaneous transmit and receive (STAR) operation in wideband radio frequency (RF) systems.

### BACKGROUND

Many communication systems, including modern military communications, electronic warfare (EW) systems, radar systems, and cellular systems often have the need to simultaneously transmit and receive (STAR) radio signals, which is also sometimes referred to as in-band full-duplex (IBFD). STAR is a method of communication in which transmitting and receiving is performed at the same center frequency at the same time. For example, some EW systems must be able to listen to a signal while jamming for 100% probability of intercepting adversarial signals. This requirement is very challenging because high-power signals from the transmit antenna can directly couple into the receive antenna at levels many orders of magnitude stronger than the signals of interest the receiver is intended to detect, an effect called self-interference. Self-interference of the transmit signal and the receive signal can, for example, damage or saturate the receiver if the transmit signal has sufficiently high power and there is low spatial (physical) isolation between the transmit and receive antennas. Furthermore, self-interference can de-sensitize the receiver and add spurious content to the receive signal if the transmit signal has moderate power and there is low spatial isolation between the antennas. Also, it can be difficult to distinguish low-power signals of interest when there is high-power leakage from the transmitter.

### BRIEF DESCRIPTION OF THE DRAWINGS

FIG. 1 shows a schematic diagram of a communication system configured for STAR operation and that is susceptible to self-interference.

FIG. 2 is a schematic diagram of a communication system configured for STAR operation and including a self-interference cancellation (SIC) circuit and that is susceptible to scalability issues necessitated by multipath delays.

FIG. 3 shows example transmit and cancellation signals as well as a time domain representation of those signals and a frequency domain representation of those signals.

FIG. 4 is a block diagram of a simultaneous transmit and receive system, in accordance with an example of the present disclosure.

FIG. 5 is a block diagram of the simultaneous transmit and receive system of FIG. 4 in further detail, in accordance with an example of the present disclosure.

FIG. 6 is a block diagram of an FPGA configured to generate a control signal for changing the settings of a cancellation circuit of the system of FIGS. 4 and 5, in accordance with an example of the present disclosure.

FIG. 7 is a flow diagram of a control loop process for controlling a cancellation circuit of the system of FIGS. 4-6, in accordance with an example of the present disclosure.

FIG. 8 shows an example of an error over a range of frequencies as measured by the system of FIGS. 4-6, in accordance with an example of the present disclosure.

FIG. 9 is a graph of frequency versus phase for the estimated error of FIG. 8, in accordance with an example of the present disclosure.

FIG. 10 is a graph of an all-pass filter applied to the estimated and measured signals at the peak error frequency of FIG. 8, in accordance with an example of the present disclosure.

FIG. 11 is a graph of filtered estimated and measured signals optimized using a gradient descent, in accordance with an example of the present disclosure.

### DETAILED DESCRIPTION

Techniques are disclosed for self-interference signal cancellation. An example is a communications platform configured with a spectral density measurement system. The spectral density measurement system includes a self-interference cancellation circuit configured to generate a cancellation signal based on a first radio signal and a second radio signal, the first radio signal transmitted and the second radio signal received simultaneously, by way of the communications platform. A first signal channel is configured to sample the first radio signal into a sampled first radio signal, and a second signal channel is configured to sample the second radio signal into a sampled second radio signal. The system further includes a cross power spectral density measurement module configured to generate a control signal for controlling the cancellation circuit based on the sampled first radio signal and the sampled second radio signal. The control signal is based on a correlation of a phase and an amplitude of the sampled first radio signal with a phase and a magnitude of the sampled second radio signal. In this manner, variance in coupling paths (e.g., amplitude and phase coupling) between the transmitter and receiver can be accounted for in a more dynamic fashion, and without necessitating a large number of components for cancelling the various coupling paths between the transmit and receive antennas. In some examples, the first signal channel includes a first high gain limiting amplifier configured to convert the first radio signal into the sampled first radio signal. The second signal channel comprises a second high gain limiting amplifier configured to convert the second radio signal into the sampled second radio signal. In some examples, the system includes a first serial-deserializer (SerDes) circuit configured to convert the first sampled radio signal into a first monobit analog signal, and a second SerDes circuit configured to convert the second sampled radio signal into a second monobit analog signal. The cross power spectral density measurement module is configured to generate the control signal for controlling the cancellation circuit based on the first monobit analog signal and the second monobit analog signal.

In some examples, a self-interference cancellation method includes cross correlating a sampled first radio signal and a sampled second radio signal (the sampled first and second radio signals provided from a hardware cancellation circuit) to produce a first cross-correlation result, and cross correlating the sampled first radio signal and a modeled second radio signal from a software model of the hardware cancellation circuit to produce a second cross-correlation result. The method further includes measuring an error between the first cross-correlation result and the second cross-correlation result to produce a measured error, and estimating an amplitude error, a phase error, and a delay error based on the measured error and the sampled second radio signal. The method further includes locating a largest frequency domain error peak in the measured error and applying a filter (e.g., an all-pass filter) to the estimated and measured signals at the peak error frequency to produce a filtered estimated signal and a filtered measured signal. The method further includes optimizing the filtered estimated signal and the filtered measured signal to obtain an optimized canceller setting. The optimized canceller setting is provided to the hardware cancellation circuit. Further examples will be apparent in view of the present disclosure.

### General Overview

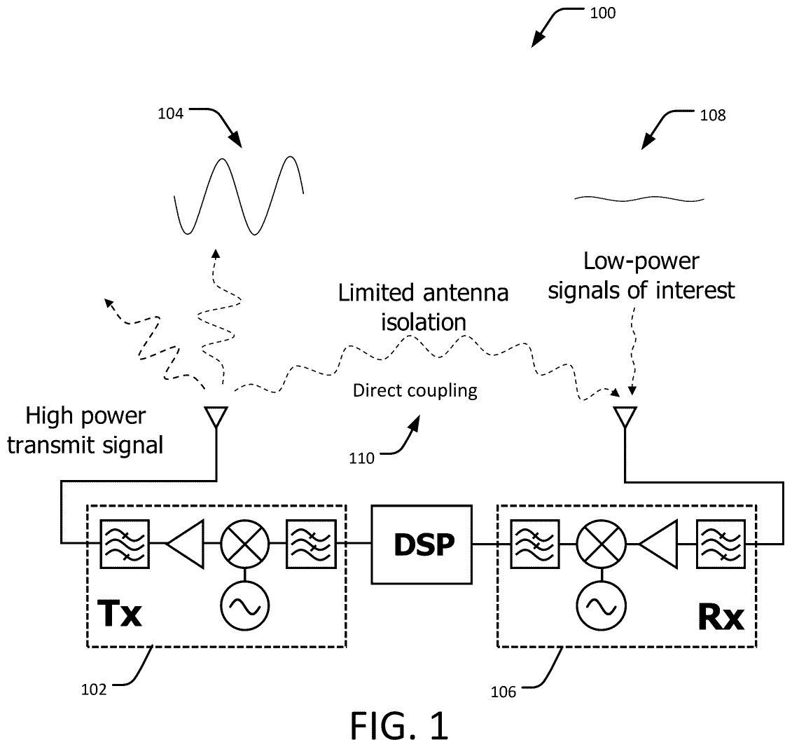

As previously noted, there are several non-trivial issues associated with STAR operation in wideband RF systems (e.g., channels using more than about 25 kHz), including providing the ability to listen to one signal at a given frequency or within a given frequency bandwidth while simultaneously jamming another signal at the same or similar frequencies. As an example, FIG. 1 shows a schematic diagram of a communication system 100 configured for STAR operation on a small platform where antennas for the transmitter 102 of a high power transmit signal and the receiver 106 of a low power signal of interest are close together (e.g., less than approximately one-quarter of the wavelength of the lowest frequency transmit and/or receive signals) and where the receiver 106 is configured to receive a receive signal 108 while the transmitter 102 is transmitting a transmit signal 104 in approximately the same time frame and in one example is simultaneously. The system is susceptible to self-interference in that leakage of the transmit signal 104 interferes with the receive signal 108 through direct coupling 110 between the transmit and receive antennas due to the close proximity of the antennas to each other and the closeness of the transmit and receive frequencies (i.e., self-interference increases as an inverse function of the distance between frequencies). In this context, direct coupling 110 is the transfer of electromagnetic radiation (e.g., radio waves) from one antenna to another. Signal interference can also be caused by body reflections and surface waves between the antennas, or via environmental reflections of the transmit signal 104 back to the receiver 106.

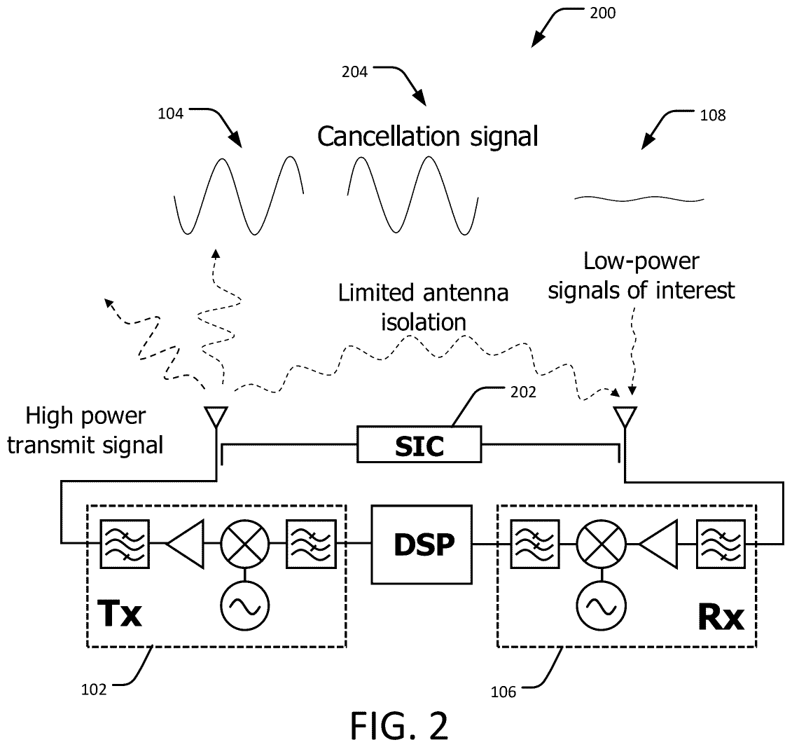

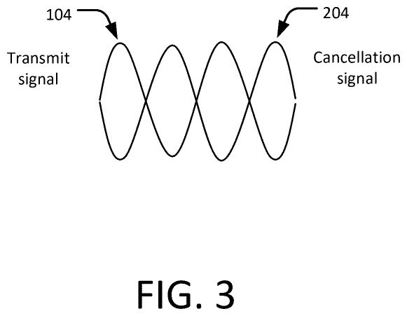

FIG. 2 is a schematic diagram of a communication platform or system 200, which includes a self-interference cancellation (SIC) circuit 202 configured to reduce self-interference. As can be seen, the SIC circuit 202 is coupled between the antennas of the transmitter 102 and the receiver 106. In operation, a small amount of the transmit signal 104 is coupled off of the transmitter 102, processed by the SIC circuit 202, and injected into the receiver 106. The SIC circuit 202 generates a cancellation signal 204 based on the transmit signal 104 by adjusting the amplitude and phase of the transmit signal 104 so that the cancellation signal 204 injected into the receiver 106 is approximately equal in amplitude but opposite in phase (for example, 180 degrees out of phase) to the transmit signal 104 (or a portion of the transmit signal), such as shown in FIG. 3, which effectively cancels the transmit signal 104 at the receiver 106 for the received signals of interest. Unfortunately, the system 200 is susceptible to scalability issues.

In more detail, the SIC circuit 202 is configured to match the frequency-dependent amplitude and phase variation of the native coupling paths between the transmit and receive antennas, over a relatively broad frequency range, so as to achieve broadband cancellation. However, the transmit-receive RF coupling characteristics often have complex and unpredictable frequency dependencies due to the antenna structures and multipath reflections which are often encountered when the antennas are mounted onto a real platform. For example, when multiple coupling paths are present between transmit and receive antennas, amplitude and phase coupling between the transmitter 102 and the receiver 106 can vary significantly. Therefore, such SIC devices may necessitate a large number of components for cancelling all of the antenna coupling paths since actual multipath delays are unknown ahead of time. In addition, due to their size, these components can be impractical in small form factors. In this manner, the system 200 can be difficult to scale to accommodate a given application, particularly applications having a small form factor and/or complex multipath scenarios.

To address the scaling concerns, some possible solutions to the self-interference problem include isolating the transmit signal from the receive signal (to eliminate the direct coupling) and/or cancelling the interference on the receive signal caused by the transmit signal. Example types of signal isolation and cancellation techniques generally include propagation isolation, analog cancellation, and digital cancellation. Propagation isolation can be used to ensure isolation of signals between transmit and receive antennas, generally by providing enough physical separation between the antennas to prevent direct coupling or environmental reflections of the signal(s). Analog cancellation uses delay, phase, and amplitude adjustments to combine an out-of-phase copy of the transmit signal with the receive signal.

Such approaches tend to be more practical in large or distributed platforms which allow for large physical spacing between the transmit and receive antennas but are often not possible in small platforms where the transmit and receive antennas tend to be relatively close together (e.g., within a common housing having a handheld form factor, or on the same platform). Moreover, coupling between transmitter and receiver antennas of a STAR system is often complicated and includes multiple coupling paths, which gives rise to a number of non-trivial issues. As such, many communication systems, notably those seeking 5G capabilities (such as small form factor mobile devices), require significant improvements in efficiency to meet increasingly challenging system requirements.

### Example Simultaneous Transmit and Receive System

An example of the present disclosure includes a system configured to measure a coupling between two antennas that are simultaneously transmitting and receiving radio signals. In some such examples, the system uses a 1-bit (monobit) cross-correlator to estimate the similarity of the signals from the two antennas. A cross-correlator is a circuit that compares the phase and amplitude of two signals and produces an output signal representing the correlation between the two signals. The output signal can be used to determine the degree of similarity between the two signals, which in turn can be used to infer information about the relationship between the two antennas and the effect the signal at each antenna has on the other signal (e.g., interference). This information can then be used to cancel or otherwise compensate for any interference caused by the transmit signal upon the receive signal to help maintain the integrity of the receive signal.

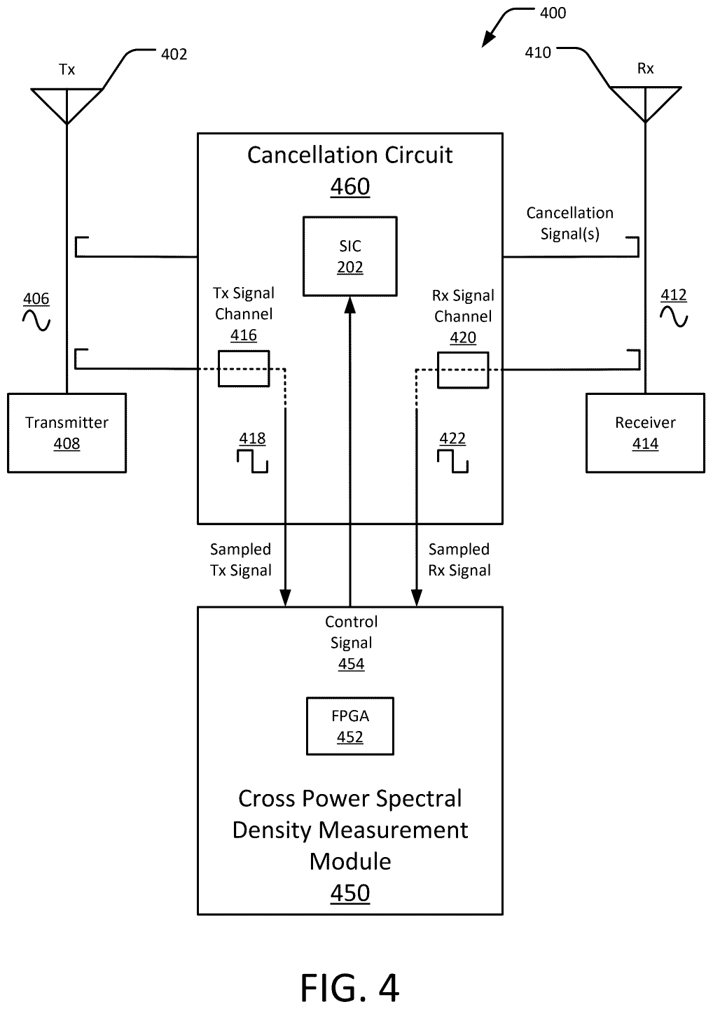

FIG. 4 is a block diagram of a simultaneous transmit and receive system 400, in accordance with an example of the present disclosure. Generally, the system 400 is configured (i) to measure the cross power spectral density of signals that are simultaneously transmitted and received in close proximity to each other, and (ii) to generate a cancellation signal to cancel out the effects of interference between the signals based on their cross power spectral density. It will be understood that examples of the present disclosure include designs accommodating either or both of these aspects independently or together. For example, the system 400 can include a cross power spectral density measurement module 450 for, among other things, measuring the cross power spectral signal density, and a cancellation circuit 460 with the SIC 202 for, among other things, generating the cancellation signal. In some examples, the cross power spectral density measurement module 450 can operate independently of the cancellation circuit 460, or portions of the cancellation circuit 460. In some other examples, the cross power spectral density measurement module 450 can operate in conjunction with the cancellation circuit 460.

The system 400 includes a transmit antenna 402 configured to transmit a first radio signal 406 generated by a transmitter 408 at a first frequency and a receive antenna 410 configured to receive a second radio signal 412 generated by a receiver 414 at a second frequency while the transmit antenna 402 is transmitting the first radio signal 406. The first radio (transmit) signal 406 and the second radio (receive) signal 412 in this example are each continuous-time sinusoidal (analog) signals. In some examples, the first and second frequencies are the same frequency (within an acceptable tolerance, if not precisely the same). In other cases, they may be intentionally different from one another. The system 400 further includes a first signal channel 416 configured to sample the first radio signal 406 into a sampled first radio signal 418, and a second signal channel 420 configured to sample the second radio signal 412 into a sampled second radio signal 422. In some examples, such as described in further detail below, the sampled first radio signal 418 and the sampled second radio signal 422 are each quantized representations of the first radio signal 406 and the second radio signal 412, respectively that can be further converted into monobit samples by downstream processing.

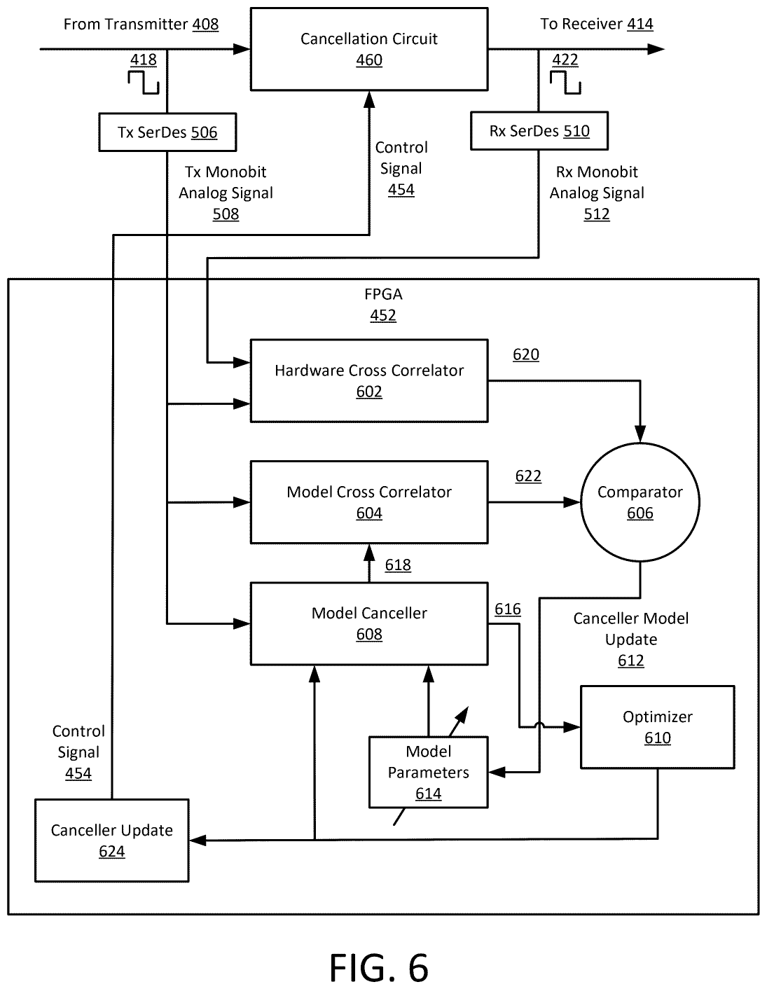

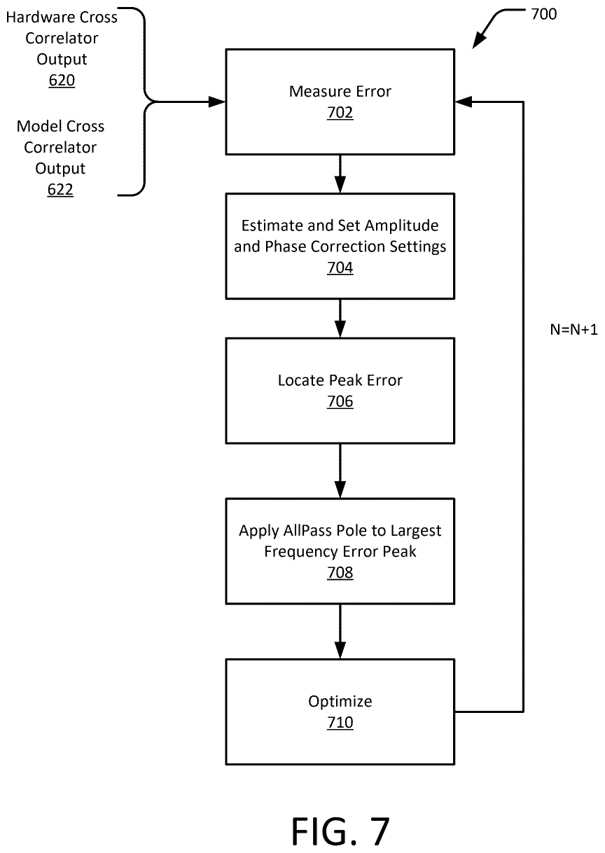

The cross power spectral density measurement module 450 in this example includes a processor, such as a field programmable gate array (FPGA) 452 (or other type of processor), configured to generate a control signal 454, which is then used to control the cancellation circuit 460. For example, the control signal 454 can be used for changing the settings of the cancellation circuit 460 based on the sampled first radio signal 418 and the sampled second radio signal 422. The control signal 454 can include variable parameters for adjusting or tuning the cancellation circuit 460 in the time domain and/or in the frequency domain. Such a control scheme is described in further detail below with respect to FIGS. 6-7.

The first signal channel 416 on the transmit chain includes a circuit configured to sample the first radio signal 406 and the second signal channel 420 on the receiver chain includes a circuit configured to sample the second radio signal 412. For example, each of the circuits of the first signal channel 416 and the second signal channel 420 can include a comparator, which quantizes the first radio signal 406 and the second radio signal 412, respectively via coupling with the transmit antenna 402 and the receive antenna 410, into a sampled voltage (or value) relative to a ground or reference voltage (or value). The comparator is fast and consumes relatively little power in comparison to some multi-bit sampling techniques. In this manner, the first signal channel 416 and the second signal channel 420 each act as a receiver for amplifying, filtering, and sampling the first radio signal 406 and the second radio signal 412, respectively, so that downstream components such as the cross power spectral density measurement module 450 can further process the signals. For instance, the FPGA 452 can be configured to generate the control signal 454 based on the sampled first radio signal 418 and the sampled second radio signal 422, or monobit equivalents of these analog signals. In some examples, the control signal 454 includes parameters for tuning the cancellation circuit 460 in the time domain and/or in the frequency domain. For instance, the cancellation circuit 460 can include tunable capacitors and/or resonators, which enable tunable bandwidth processing of the signals, and variable delay, phase, and/or attenuation components, which enable tunable time delay processing of the signals.

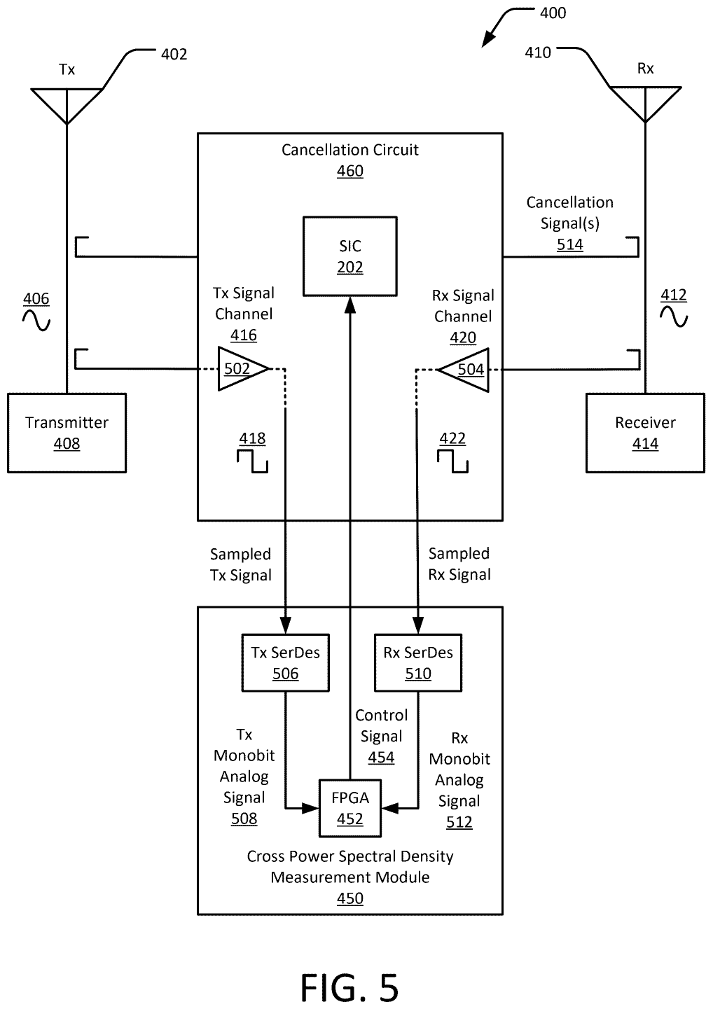

FIG. 5 is a block diagram of the simultaneous transmit and receive system 400 of FIG. 4 in further detail, in accordance with an example of the present disclosure. In this example, the first signal channel 416 includes a first high gain limiting amplifier 502 configured to convert the first radio signal 406 into the sampled first radio signal 418. The second signal channel 420 includes a second high gain limiting amplifier 504 configured to convert the second radio signal 412 into the sampled second radio signal 422. The first high gain limiting amplifier 502 and the second high gain limiting amplifier 504 can be implemented, for example, with instantaneous frequency measurement receiver limiting amplifiers, or fiber-optic type limiting amplifiers, or other limiting amplifiers having relatively low noise figure and power consumption, suitable for a given application.

The first high gain limiting amplifier 502 and the second high gain limiting amplifier 504 sample and quantize the first radio signal 406 and the second radio signal 412, which are continuous-time sinusoids, into single-bit square waves (the sampled first radio signal 418 and the sampled second radio signal 422). A positive voltage of the sampled first radio signal 418 or the sampled second radio signal 422 represents a first logic state (e.g., logical one or true) and a negative voltage represents a second logic state (e.g., a logical zero or false). The first signal channel 416 and the second signal channel 420 can each sample the signals at high speed, such as 6 to 12 gigabits per second.

In this example, the cross power spectral density measurement module 450 includes a first serial-deserializer (SerDes) circuit 506 on the transmit chain configured to convert the sampled first radio signal 418 into a first monobit analog signal 508, and a second SerDes circuit 510 on the receiver chain configured to convert the sampled second radio signal 422 into a second monobit analog signal 512. A monobit analog signal is a sample of a signal where, for example, a positive analog voltage sample represents a logical one (or logical true) and a negative analog voltage sample represents a logical zero (or logical false), or vice versa. Thus, in this example, the first monobit analog signal 508 and the second monobit analog signal 512 are not digital signals but effectively represent the first logic state and the second logic state as binary conditions (true or false).

The first SerDes circuit 506 and the second SerDes circuit 510 can be used to interface with the antennas 402, 410 and to perform signal cross-correlation. In some examples, the FPGA 452 can be used to implement one or more digital logic circuits, including the first SerDes circuit 506 and the second SerDes circuit 510, among other functions. In FIG. 5, the first SerDes circuit 506 and the second SerDes circuit 510 are shown as separate blocks for clarity.

The first SerDes circuit 506 and the second SerDes circuit 510 are each high-speed interfaces that convert parallel data into serial data, and vice versa, and are similar in function to high-speed 1-bit comparators. In this example, the first SerDes circuit 506 and the second SerDes circuit 510 are preceded by the first high gain limiting amplifier 502 and the second high gain limiting amplifier 504, which help to overcome certain non-idealities in the first radio signal 406 and the second radio signal 412, such as a small residual hysteresis and direct current (DC) offsets, by changing the continuous waveforms of the first radio signal 406 and the second radio signal 412 into square wave-type waveforms of the signals.

The first SerDes circuit 506 and the second SerDes circuit 510 each effectively act as an analog-to-digital converter for converting the sampled first radio signal 418 into the first monobit analog signal 508 and for converting the sampled second radio signal 422 into the second monobit analog signal 512 for further processing by the FPGA 452. However, as noted above, in some examples the first monobit analog signal 508 and the second monobit analog signal 512 are not digital signals but are effectively analog representations of a digital signal.

In this example, the FPGA 452 is configured to generate the control signal 454 for controlling the cancellation circuit 460 based on the first radio signal 406 and the second radio signal 412 (e.g., monobit samples of these signals). As discussed in further detail below, the FPGA 450 is configured to implement logic to cross-correlate the first monobit analog signal 508 and the second monobit analog signal 512 to determine if there are any similarities that are caused by self-interference, which are then cancelled out by the SIC 202 of the cancellation circuit 460.

The first SerDes circuit 506 and the second SerDes circuit 510 each sample the limiting-amplifier processed signals (e.g., the sampled first radio signal 418 and the sampled second radio signal 422 from the cancellation circuit 460) at a rate of, for example, 6-12 GHz, and buffer the sampled signals (e.g., the first monobit analog signal 508 and the second monobit analog signal 512) for further processing by the FPGA 452. The FPGA 452 then processes the sampled signals in batches such as 40 samples per FPGA clock cycle against a software model of the cancellation circuit 460 (e.g., the model canceller 608 of FIG. 6). For instance, in one such example, the FPGA 452 is clocked at a rate of 150 MHz, where 80 samples (40 from the transmit-side of the cancellation circuit 460 and 40 from the receive-side of the cancellation circuit 460) are stored in 1024-element buffers of the FPGA 452.

In this example, upon each successive FPGA clock cycle, the FPGA 452 parallel processes 40 new samples from the buffers, performs cross-correlation analysis of the samples, and accumulates the results of the cross-correlation analysis. The cross-correlation analysis can be implemented, for example, as a 1024-tap cross correlator, where the cross correlator has 1024 time-delayed inputs (taps). Each tap represents a unique delay offset in the cross-correlation function, which spans 200 nS.

The 1024-tap cross correlator contains 1024 32-bit registers and can be accumulated for a finite number of clock cycles, typically in the microsecond range. However, it will be understood that a longer accumulation time may result in improved measurement variance. The cross-correlation result is then converted to a 32-bit floating point value, which is fed to a fast Fourier transform (FFT). Both the time-domain and frequency domain result (the cross power spectral density) are loaded in a memory that is accessible by the FPGA 452.

The FPGA 452 provides the control signal 454 to the cancellation circuit 460 based on the time-domain and frequency domain results, which represent the RF coupling between the transmitter 408 and the receiver 414 while simultaneously transmitting and receiving signals. In turn, the cancellation circuit 460 is configured to generate a cancellation signal 514 based on the settings in the control signal 454 (e.g., canceller state coefficients). The cancellation circuit 460 injects the cancellation signal 514 into the second radio signal 412, thereby cancelling the self-interference of the first radio signal 406.

### Self-Interference Signal Cancellation

In some examples, the FPGA 452 is further configured to compare representations of the sampled first radio signal 418 and the sampled second radio signal 422 in each of a time domain and a frequency domain, where the control signal 454 is further based on the comparison, such as described in further detail with respect to FIGS. 6 and 7. For instance, RF coupling between the first radio signal 406 and the second radio signal 412 can be measured using methods such as cross power spectral density measurements or impulse response between the transmit antenna 402 and the receive antenna 410. With such techniques, the cancellation circuit 460 is configured in the s-plane (the complex frequency response of a continuous time signal). However, the mapping between the z-plane (the complex frequency response of a discrete signal, i.e., the sampled input signal) and the s-plane is not straightforward and there generally exists no one-to-one relationship. Further, the setting of the cancellation circuit is slow as compared microprocessor calculation speeds and the cancellation operations must be performed with a small number of physical hardware iterations.

Thus, in accordance with an example of the present disclosure, the cancellation circuit 460, and more specifically, the canceller state coefficients, are controlled by the FPGA 452. That is, rather than having a hardware control loop within the cancellation circuit 460, instead the FPGA 452 is configured to execute a control loop for controlling the cancellation circuit 460 using a software model of the cancellation circuit 460. The control loop in the FPGA 452 indirectly converges a prediction of the cancellation circuit 460. As noted above, the FPGA 452 can operate at a very high speed, such as 25 nanoseconds per optimization step, which allows the control loop to execute much more quickly than if it was implemented in hardware in the cancellation circuit 460. The model convergence results are then used to set the cancellation circuit 460. Additional RF cross spectral channel measurements can be taken upon each hardware update, where this information is also used to continuously calibrate the software model.

### Realtime Closed Loop Configuration S Plane Radio Frequency Cancellation Hardware

FIG. 6 is a block diagram of the FPGA 452 in further detail, in accordance with an example of the present disclosure. The FPGA 452 includes a hardware cross correlator 602, a model cross correlator 604, a comparator 606, a model canceller 608, and an optimizer 610. The model canceller 608 simulates the cancellation circuit 460 in software.

The FPGA 452 provides an instantiation of a 1-bit cross power spectral density estimator via the model cross correlator 604 and an associated cancellation configuration algorithm via the model canceller 608 and the optimizer 610. The cancellation circuit 460 is configured by the FPGA 452, via the control signal 454, using the model canceller 608. The model canceller 608 includes a control loop that indirectly converges a prediction of the cancellation circuit 460 based on the sampled first radio signal 418 and the sampled second radio signal 422. Model parameters 614 for configuring the model canceller 608 are seeded with a set of initialized canceller state coefficients. The optimizer 610 produces convergence results of the model canceller 608, which in turn sets the operational parameters of the cancellation circuit 460.

Additional RF cross spectral channel measurements are taken upon each update 624 of the cancellation circuit 460 to continuously calibrate (tune) the model parameters 614 for the model canceller 608. Such calibration reduces the measured error between the model canceller 608 and the cancellation circuit 460. Gain values are used to set how fast each parameter can change during each update, e.g., to prevent changes that are too abrupt or too slow. Limit values are used to limit the extremes of each parameter.

The hardware cross correlator 602 cross-correlates the sampled first radio signal 418 and the sampled second radio signal 422 from the cancellation circuit 460, such as described above with respect to FIGS. 4-5. The model cross correlator 604 cross-correlates the sampled first radio signal 418 and a modeled second radio signal 618, which is simulated by the model canceller 608. The comparator 606 compares the outputs 620 and 622 of the hardware cross correlator 602 and the model cross correlator 604, respectively, and provides a canceller model update 612 to the model canceller 608 by updating the model parameters 614 of the model canceller 608. The output 620 represents the cross-correlation values for the cancellation circuit 460 (the hardware canceller) and the output 622 represents the cross-correlation values for the model canceller 608 (the software canceller).

The model canceller 608 is a configurable software model of the cancellation circuit 460. While the cancellation circuit 460 receives the first radio signal 406 and the second radio signal 412 as inputs, the model canceller 608 receives the sampled first radio signal 418 and the modeled second radio signal 618 as inputs. The model canceller 608 models the behavior of the cancellation circuit 460 such that an output 616 of the model canceller 608 is similar to the sampled second radio signal 422 responsive to the cancellation signal 514 as applied to the second radio signal 412 by the cancellation circuit 460.

As noted above, due to the complexities of self-interference in a STAR system, the cancellation circuit 460 (a hardware circuit) is too slow to be used in the signal interference cancellation control loop. Thus, the model canceller 608 is a software representation of the cancellation circuit 460 that executes within the FPGA 452, which is relatively fast (˜25 nS per step) as compared to the hardware in the cancellation circuit 460.

The optimizer 610 is configured to modify the settings of the cancellation circuit 460 and the settings of the model canceller 608 by applying an optimization algorithm to obtain a convergence of the output 616 of the model canceller 608. For example, a gradient descent can be applied to the output 616 to obtain a convergence of the output 616 of the model canceller 608. It will be understood that other machine learning techniques can be used instead of gradient descent to obtain the optimized settings for the cancellers.

### Optimization of Cancellation Circuit

FIG. 7 is a flow diagram of a control loop process 700 for controlling the cancellation circuit 460, in accordance with an example of the present disclosure. The process 700 can be implemented, for example, in the FPGA 452.

The process 700 includes measuring 702 the error between the cancellation circuit 460 (the output 620 of the hardware cross correlator 602) and the model canceller 608 (the output 622 of the model cross correlator 604). Recall that the hardware cross correlator 602 cross-correlates the sampled first radio signal 418 and the sampled second radio signal 422 from the cancellation circuit 460, and the model cross correlator 604 cross-correlates the sampled first radio signal 418 and a modeled second radio signal 618 from the model canceller 608.

The measured error between the cancellation circuit 460 and the model canceller 608 is defined as

$$Error [ F ] = 20 {Log}_{10} ( ABS [ \frac{E s t [ F ] - M e a s [ F ]}{M e a s [ F ]} ] )$$

where Est[F] is the estimated frequency produced by the model canceller 608) and Meas[F] is the measured frequency produced by the cancellation circuit 460. In some examples, the measured error can be based on an internal model (e.g., a hidden plant model) of the cancellation circuit 460 such that coefficient adjustments can be made in software, allowed to converge, then applied to the cancellation circuit 460. The model may be used, for instance, when it takes too long to observe the result of each change to the cancellation circuit 460. The internal model predicts the result of each such change, but applies the changes and measures the results (rather than internally predicting) less often.

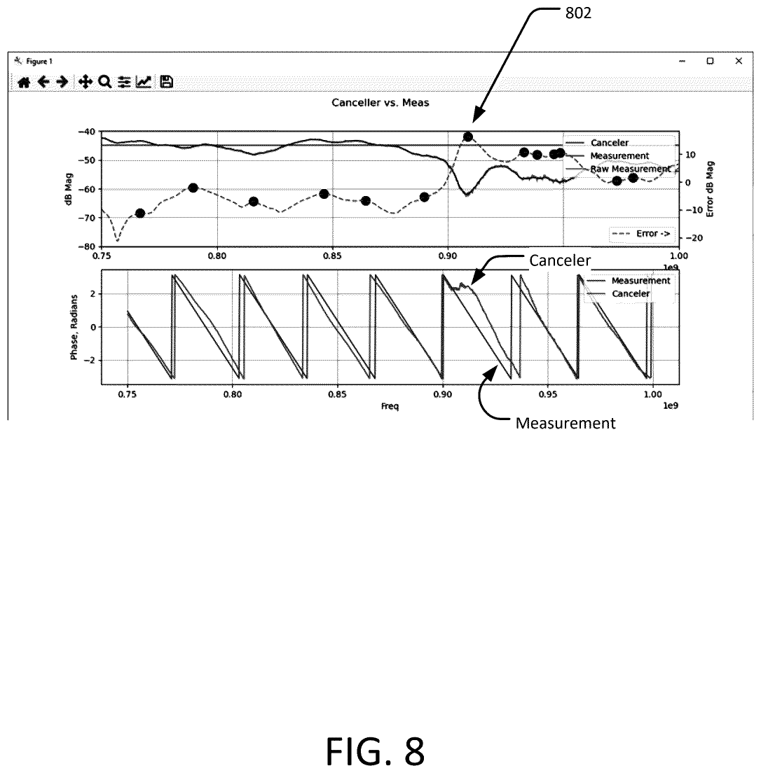

FIG. 8 shows an example of the measured error over a range of frequencies.

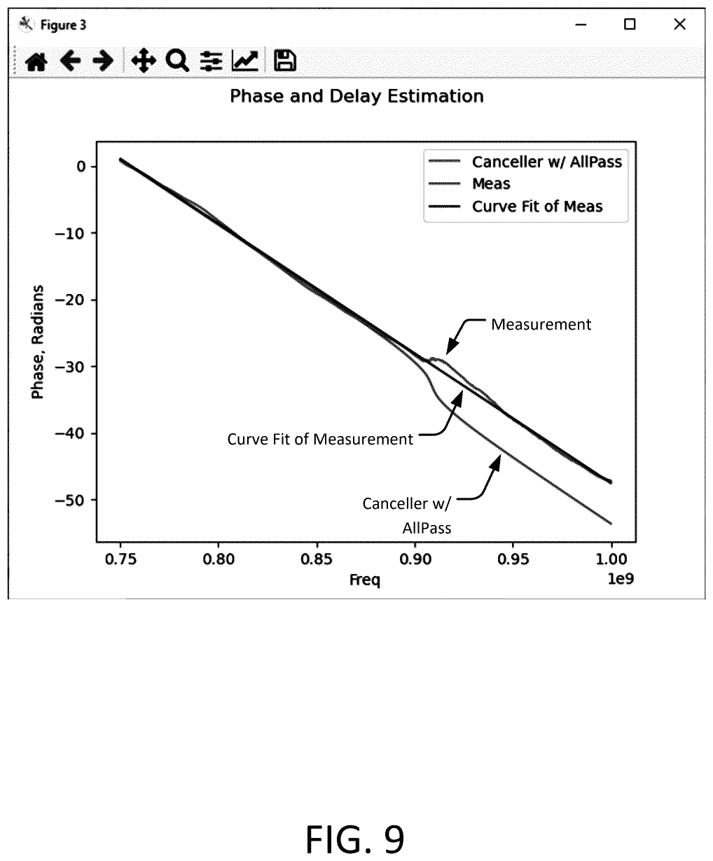

The process 700 further includes estimating 704 an amplitude error, a phase error, and/or a delay error using Linear Least Squares Estimation (LLSE) based on the measured error Error[F] and the output of the cancellation circuit 460 (e.g., the sampled second radio signal), such as shown in FIG. 9. FIG. 9 is a graph of frequency versus phase for the estimated error.

The cross-correlation process 700 further includes locating 706 a largest frequency domain error peak in the measured error. The peak error is defined as:

$${Error}_{peak} = {max}_{F} [ \frac{d}{dF} Error [ F ] = 0 ]$$

FIG. 8 shows an example of a peak error, indicated at 802, over a range of frequencies.

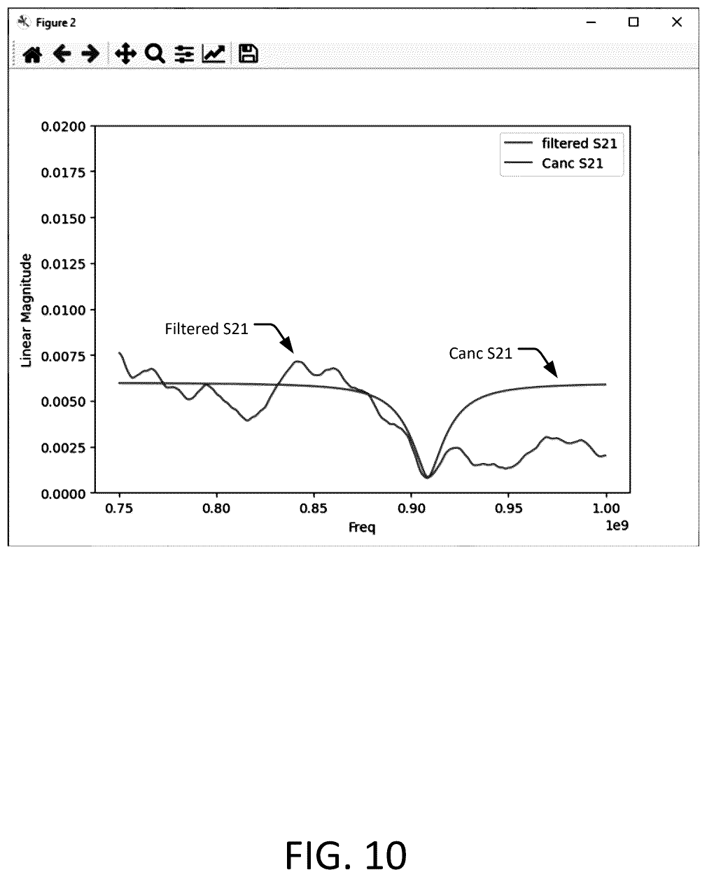

The process 700 further includes applying 708 a canceller all-pass single pole filter to the estimated and measured signals at the peak error frequency Errorₚₑₐₖ, such as shown in FIG. 10. The all-pass filter configures one element of the cancellation circuit 460 to best match the peak error 802 by use of a look up table (LUT), although it will be appreciated that other suitable types of filters can be used.

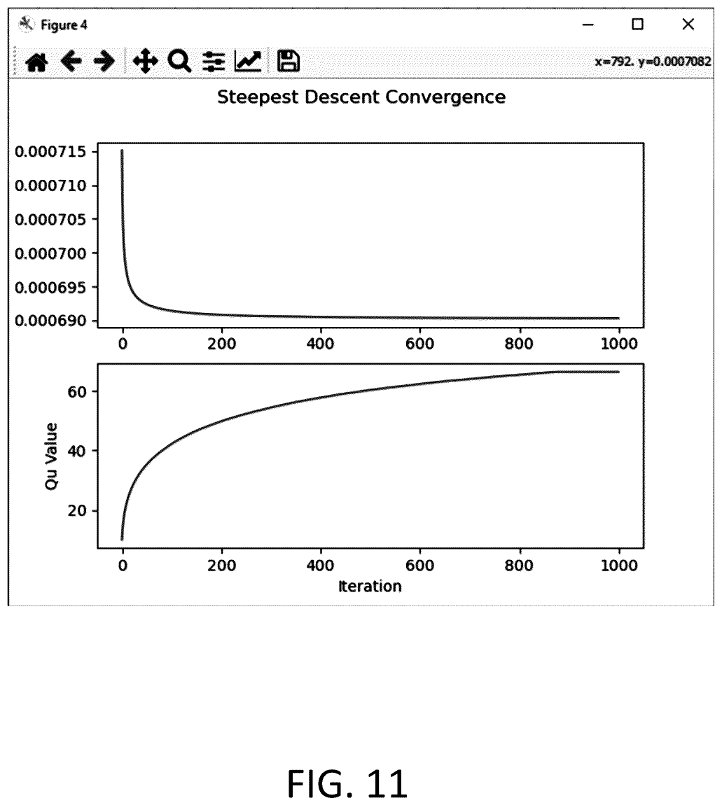

The process 700 further includes optimizing 710 the filtered estimated and measured signals, for example, using a gradient descent to obtain new canceller settings, such as shown in FIG. 11. The gradient descent minimizes the total error using the following equation:

$${a}_{n + 1} = {a}_{n} - γ ∇ F + {C}_{E r r o r}$$

where a is the coefficient vector, γ is the gain, ∇ is the mathematical gradient, and C_{Error} is the aggregate error function defined as:

$${C}_{E r r o r} = \sum \vert {( Es t [ F ] - M e a s [ F ] )}^{2} \vert$$

In some examples, other optimization techniques can be used, such as genetic programming, neural networks, or machine learning.

The optimized settings are then passed to the cancellation circuit 460 and the model canceller 608. N is then advanced to N+1 and the process 700 is repeated, where N is between 1 and 16, depending upon the complexity of the cancellation circuit 460.

### ADDITIONAL EXAMPLES

Numerous embodiments will be apparent in light of the present disclosure, and features described herein can be combined in any number of configurations.

Example 1 provides a self-interference cancellation method. The method includes cross correlating, by a processor, a sampled first radio signal and a sampled second radio signal from a hardware cancellation circuit to produce a first cross-correlation result; cross correlating, by the processor, the sampled first radio signal and a modeled second radio signal from a software model of the hardware cancellation circuit to produce a second cross-correlation result; measuring, by the processor, an error between the first cross-correlation result and the second cross-correlation result to produce a measured error; estimating, by the processor, at least one of an amplitude error, a phase error, and a delay error based on the measured error and the sampled second radio signal; locating, by the processor, a largest frequency domain error peak in the measured error; applying, by the processor, a filter (e.g., an all-pass filter) to the estimated and measured signals at the peak error frequency to produce a filtered estimated signal and a filtered measured signal; optimizing, by the processor, the filtered estimated signal and the filtered measured signal to obtain an optimized canceller setting; and providing the optimized canceller setting to the hardware cancellation circuit.

Example 2 includes the subject matter of Example 1, wherein the estimating includes estimating the amplitude error, the phase error, and the delay error using Linear Least Squares Estimation (LLSE).

Example 3 includes the subject matter of any one of Examples 1 and 2, wherein the optimizing includes optimizing the filtered estimated signal and the filtered measured signal using a gradient descent.

Example 4 includes the subject matter of any one of Examples 1-3, wherein the optimizing is based on a set of initial conditions, and wherein the method comprises repeating the measuring, the estimating, the locating, the applying, the optimizing, and the providing based on the optimized canceller setting.

Example 5 includes the subject matter of any one of Examples 1-4, further comprising generating, by the hardware cancellation circuit, a cancellation signal based on the optimized canceller setting.

Example 6 includes the subject matter of any one of Examples 1-5, wherein the sampled first radio signal is transmitted and the sampled second radio signal is received simultaneously.

Example 7 includes the subject matter of any one of Examples 1-6, further comprising converting the first sampled radio signal into a first monobit analog signal and converting the second sampled radio signal into a second monobit analog signal.

Example 8 includes the subject matter of Example 7, wherein the first monobit analog signal and the second monobit analog signal are each sampled at between 6 GHz and 12 GHz.

Example 9 includes the subject matter of any one of Examples 1-8, further comprising cross correlating 40 samples of the sampled first radio signal and 40 samples of the sampled second radio signal per clock cycle of the processor.

Example 10 includes the subject matter of Example 9, wherein the clock cycle of the processor is 150 MHz.

Example 11 includes the subject matter of any one of Examples 1-10, further comprising accumulating a result of cross correlating the first sampled radio signal and the second sampled radio signal in a 1024-tap cross-correlator.

Example 12 includes the subject matter of Example 11, further comprising converting the result into a 32-bit floating point value and applying the 32-bit floating point value to a fast Fourier transform (FFT) to produce a time domain result and a frequency domain result.

Example 13 includes the subject matter of any one of Examples 1-12, wherein a frequency of the sampled first radio signal is different from a frequency of the sampled second radio signal.

Example 14 provides a self-interference cancellation system comprising a self-interference cancellation circuit configured to generate a cancellation signal based on a first radio signal and a second radio signal, the first radio signal transmitted and the second radio signal received simultaneously; and a cross power spectral density measurement module configured to generate a control signal for controlling the cancellation circuit based on the first radio signal and the second radio signal.

Example 15 includes the subject matter of Example 14, further comprising a first sampling circuit configured to convert the first radio signal into a first monobit analog signal; and a second sampling circuit configured to convert the second radio signal into a second monobit analog signal, wherein the cross power spectral density measurement module is configured to generate the control signal based on the first monobit analog signal and the second monobit analog signal.

Example 16 includes the subject matter of any one of Examples 14 and 15, wherein the cross power spectral density measurement module is configured to: cross-correlate a sample of the first radio signal and a sample of the second radio signal from a hardware cancellation circuit to produce a first cross-correlation result; cross-correlate the sampled first radio signal and a modeled second radio signal from a software model of the hardware cancellation circuit to produce a second cross-correlation result; measure an error between the first cross-correlation result and the second cross-correlation result to produce a measured error; estimate an amplitude error, a phase error, and a delay error based on the measured error and the sampled second radio signal; locate a largest frequency domain error peak in the measured error; apply an all-pass filter to the estimated and measured signals at the peak error frequency to produce a filtered estimated signal and a filtered measured signal; optimize the filtered estimated signal and the filtered measured signal to obtain an optimized canceller setting; and provide the optimized canceller setting to the hardware cancellation circuit.

Example 17 includes the subject matter of Example 16, wherein the optimizing is based on a set of initial conditions, and wherein the cross power spectral density measurement module is configured to repeat the measuring, the estimating, the locating, the applying, the optimizing, and the providing based on the optimized canceller setting.

Example 18 includes the subject matter of Example 17, wherein the cross power spectral density measurement module is configured to generate, by the hardware cancellation circuit, a cancellation signal based on the optimized canceller setting.

Example 19 provides a computer program product including one or more non-transitory computer readable storage mediums having instructions encoded thereon that when executed by one or more processors cause a process to be carried out for self-interference cancellation, the process comprising measuring, by the one or more processors, an error between an output of a hardware cancellation circuit and an output of a software model of the hardware cancellation circuit; estimating, by the one or more processors, at least one of an amplitude error, a phase error, and a delay error based on the measured error and the output of the hardware cancellation circuit; locating, by the one or more processors, a largest frequency domain error peak in the measured error; applying, by the one or more processors, a filter to the estimated and measured signals at the peak error frequency to produce a filtered estimated signal and a filtered measured signal; optimizing, by the one or more processors, the filtered estimated signal and the filtered measured signal to obtain an optimized canceller setting; and providing the optimized canceller setting to the hardware cancellation circuit.

Example 20 includes the subject matter of Example 19, the process further comprising converting the output of the hardware cancellation circuit into a monobit analog signal, wherein the error is measured between the monobit analog signal and the output of the software model of the hardware cancellation circuit.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

What is claimed is:

1. A self-interference cancellation method comprising:
cross correlating, by a processor, a sampled first radio signal and a sampled second radio signal from a hardware cancellation circuit to produce a first cross-correlation result;
cross correlating, by the processor, the sampled first radio signal and a modeled second radio signal from a software model of the hardware cancellation circuit to produce a second cross-correlation result;
measuring, by the processor, an error between the first cross-correlation result and the second cross-correlation result to produce a measured error;
estimating, by the processor, at least one of an amplitude error, a phase error, and a delay error based on the measured error and the sampled second radio signal;
locating, by the processor, a largest frequency domain error peak in the measured error;
applying, by the processor, a filter to the estimated and measured signals at the peak error frequency to produce a filtered estimated signal and a filtered measured signal;
optimizing, by the processor, the filtered estimated signal and the filtered measured signal to obtain an optimized canceller setting; and
providing the optimized canceller setting to the hardware cancellation circuit.

2. The method of claim 1, wherein the estimating includes estimating the amplitude error, the phase error, and the delay error using Linear Least Squares Estimation (LLSE).

3. The method of claim 1, wherein the optimizing includes optimizing the filtered estimated signal and the filtered measured signal using a gradient descent.

4. The method of claim 1, wherein the optimizing is based on a set of initial conditions, and wherein the method comprises repeating the measuring, the estimating, the locating, the applying, the optimizing, and the providing based on the optimized canceller setting.

5. The method of claim 1, further comprising generating, by the hardware cancellation circuit, a cancellation signal based on the optimized canceller setting.

6. The method of claim 1, wherein the sampled first radio signal is transmitted and the sampled second radio signal is received simultaneously.

7. The method of claim 1, further comprising converting the first sampled radio signal into a first monobit analog signal and converting the second sampled radio signal into a second monobit analog signal.

8. The method of claim 7, wherein the first monobit analog signal and the second monobit analog signal are each sampled at between 6 GHz and 12 GHz.

9. The method of claim 1, further comprising cross correlating 40 samples of the sampled first radio signal and 40 samples of the sampled second radio signal per clock cycle of the processor.

10. The method of claim 9, wherein the clock cycle of the processor is 150 MHz.

11. The method of claim 1, further comprising accumulating a result of cross correlating the first sampled radio signal and the second sampled radio signal in a 1024-tap cross-correlator.

12. The method of claim 11, further comprising converting the result into a 32-bit floating point value and applying the 32-bit floating point value to a fast Fourier transform (FFT) to produce a time domain result and a frequency domain result.

13. The method of claim 1, wherein a frequency of the sampled first radio signal is different from a frequency of the sampled second radio signal.

14. A self-interference cancellation system comprising:
a self-interference cancellation circuit configured to generate a cancellation signal based on a first radio signal and a second radio signal, the first radio signal transmitted and the second radio signal received simultaneously; and
a cross power spectral density measurement module configured to generate a control signal for controlling the cancellation circuit based on the first radio signal and the second radio signal.

15. The system of claim 14, further comprising:
a first sampling circuit configured to convert the first radio signal into a first monobit analog signal; and
a second sampling circuit configured to convert the second radio signal into a second monobit analog signal,
wherein the cross power spectral density measurement module is configured to generate the control signal based on the first monobit analog signal and the second monobit analog signal.

16. The system of claim 14, wherein the cross power spectral density measurement module is configured to:
cross-correlate a sample of the first radio signal and a sample of the second radio signal from a hardware cancellation circuit to produce a first cross-correlation result;
cross-correlate the sampled first radio signal and a modeled second radio signal from a software model of the hardware cancellation circuit to produce a second cross-correlation result;
measure an error between the first cross-correlation result and the second cross-correlation result to produce a measured error;
estimate an amplitude error, a phase error, and a delay error based on the measured error and the sampled second radio signal;
locate a largest frequency domain error peak in the measured error;
apply an all-pass filter to the estimated and measured signals at the peak error frequency to produce a filtered estimated signal and a filtered measured signal;
optimize the filtered estimated signal and the filtered measured signal to obtain an optimized canceller setting; and
provide the optimized canceller setting to the hardware cancellation circuit.

17. The system of claim 16, wherein the optimizing is based on a set of initial conditions, and wherein the cross power spectral density measurement module is configured to repeat the measuring, the estimating, the locating, the applying, the optimizing, and the providing based on the optimized canceller setting.

18. The system of claim 17, wherein the cross power spectral density measurement module is configured to generate, by the hardware cancellation circuit, the cancellation signal based on the optimized canceller setting.

19. A computer program product including one or more non-transitory computer readable storage mediums having instructions encoded thereon that when executed by one or more processors cause a process to be carried out for self-interference cancellation, the process comprising:
measuring, by the one or more processors, an error between an output of a hardware cancellation circuit and an output of a software model of the hardware cancellation circuit;
estimating, by the one or more processors, at least one of an amplitude error, a phase error, and a delay error based on the measured error and the output of the hardware cancellation circuit;
locating, by the one or more processors, a largest frequency domain error peak in the measured error;
applying, by the one or more processors, a filter to the estimated and measured signals at the peak error frequency to produce a filtered estimated signal and a filtered measured signal;
optimizing, by the one or more processors, the filtered estimated signal and the filtered measured signal to obtain an optimized canceller setting; and
providing the optimized canceller setting to the hardware cancellation circuit.

20. The computer program product of claim 19, wherein the process further comprises converting, by the one or more processors, the output of the hardware cancellation circuit into a monobit analog signal, wherein the error is measured between the monobit analog signal and the output of the software model of the hardware cancellation circuit.
